(19) United States
(12) Patent Application Publication
(10) Pub. No.: US 2004/0083275 A1
(43) Pub. Date: Apr. 29, 2004

(54) Method, business processes and apparatus for remote data, image and video collection, transmission and distribution using cellular electronic serial number enabled devices

(76) Inventor: John Strisower, Chico, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/682,504

(22) Filed: Oct. 8, 2003

Related U.S. Application Data
(60) Provisional application No. 60/418,066, filed on Oct. 11, 2002.

(51) Int. Cl. G06F 15/16; G06F 13/00

(52) U.S. Cl. 709/217; 710/33

(57) ABSTRACT

Disclosed is a process of making images or other data from an image capturing device or other data capturing device or a combination thereof available to one or more authorized user, the capturing device having an electronically readable device serial number and cellular Internet communication capability, and (a) providing use information specifying said one or more authorized user of said images or other data, (b) capturing said images or other data and (c) accessing a cellular service provider (CSP) or a personal communications service provider (PCSP) with said cellular Internet communication capability for initiating the transmitting of said images or other data to a service provider associated with said device serial number, the process comprising said CSP or PCSP transmitting said prepared images or other data to an application service provider (ASP) associated with said device serial number to enable said ASP to associate said device serial number and said use information to provide to said set of authorized users said images or other data.

### RELATED APPLICATIONS

Priority is claimed to Provisional Application Serial No. 60/418,066 filed on Oct. 11, 2002.

### BACKGROUND OF THE INVENTION

The invention relates generally to methods for collecting data, photographic images, sound and video using devices with unique electronic serial numbers (ESN) and then receiving the collected data over the Internet on a secure application service provider's (ASP's) web site keyed to the electronic serial number(s) of the capturing device(s).

While many devices are available for data collection, photographic image collection (digital cameras) and video, these devices require subsequent connection to a computer to download the collected data. This downloaded data can then be uploaded to Internet web sites where other users can access the information.

Public safety officers, news reporters, field data collection devices (meter readers and package delivery scanners) and general consumers could greatly benefit from the service provided by devices that automatically and wirelessly transmit data to designated, secure websites for immediate, secure, worldwide access. For example, a digital camera on the top of a police vehicle triggered to take a series of photos of an officer's current situation and then wirelessly transmitted to the web could provide an almost real-time and cost effective solution for central dispatchers to “see” what officers are encountering and thus be able to respond accordingly. News reporters could take photos and write stories and then click the “send” button which would make the photos and story text available via the Internet to any authorized user worldwide immediately.

Consumers that would like a digital alternative to the standard disposable film camera currently must pay for processing the film of the disposable camera and wait to receive digital images on CD or floppy disk via the U.S. mail or in person at a film processing lab. The described system provides the methods, apparatus and business processes to enable disposable, wireless, real-time digital photography directly to the Internet without a consumer needing to upload it via their computer. There is a need for a simple to use and cost effective method for consumers and business users to capture real-time data and images that can be accessed by one or more authorized user, wirelessly, worldwide in a cost effective method. As will be seen, described herein this capability is provided in a useful and elegant manner.

### BRIEF DESCRIPTION OF THE DRAWINGS

FIG. 1 is an overview of the entire system illustrating components and business entities to facilitate one example of the invention.

FIG. 2 is a diagram of a Disposable Cellular Web Camera illustrating possible embodiments of external features for such a device.

FIG. 3 is a transmission flowchart illustrating logic used by a Cellular Web Camera to transmit pictures to the Web via the Cellular Service Provider (CSP).

FIG. 4 is a diagram illustrating how a non-disposable embodiment of the invention could be implemented using Universal Serial Bus (USB) connectivity to a Pocket PC (PDA).

FIG. 5 illustrates four different types of billing and processing models that are useful for different types of applications of the invention for differing end user requirements.

### SUMMARY

Useful methods, apparatus and business processes for remote, real-time data and/or image collection, wireless transmission and distribution for access and use by authorized Internet users real-time, worldwide, are provided as described. Digital photographic electronics and/or other data capture/collection devices and serialized cellular/radio transmission techniques using an electronic serial number as described herein allow for standardized, real-time, wireless, anonymous, secure, globally accessible and cost effective image and data collection and distribution. There are numerous different configurations described herein that are viable for different applications for different user types. Consumers may use this as a personal photographic album and distribution tool. More sophisticated consumers may use this to provide web based albums and secure access to authorized individuals utilizing existing digital photographic equipment and USB or other device interfaces that provide cellular web transmission to a more configurable and feature rich ASP web hosting environment with a billing arrangement by picture or transfer time interval, storage time, size, and the like. Other consumers may wish to utilize a hybrid approach by buying an inexpensive cellular web camera that uses prepaid photo cards. For example, the device could be programmed to send all images to specific folders within the consumer's secure ASP web site by date. As a prepaid account is depleted, more can be added by credit card or cash procurement of prepaid cards sold at retail locations or over the Internet. The cards would then be used, via a web based ASP interface, to authorize the cellular web cam ESN to resume transmitting images.

Commercial users could have a different business process where multiple devices and their corresponding ESN would be aggregated to a specialized and customized ASP hosting site or data feed using web services, XML or other mutually specified data transmission protocol. For example, public utility meter readers, potentially hundreds or even thousands of devices and employees, could have all devices channeled to their specific ASP hosted web site whereby the office could see real-time data being collected by each meter reader in the field. This example would utilize a business process whereby the CSP would bill the commercial enterprise for transmission by accumulated minutes, records, data volume/bandwidth used or any of a number of other readily available metrics. The ASP service would also bill the utility enterprise for custom setup, software development, security, hosting service, bandwidth, storage and, again, numerous other readily available metrics.

Parcel delivery companies utilizing the cellular web data collection application described may wish to have data collected and aggregated and then forwarded by mutually agreed upon protocol to their designated Internet server/site address for further processing. The described embodiment allows for contract and business process flexibility herein. The parcel delivery firm could be billed by the CSP for transmission time, bandwidth, number of records (package scans for example) as well as numerous other readily available metrics. The ASP business process could be simply fees for setup and custom protocol definition and testing and then billing for ongoing aggregation and forwarding of collected data by record, transfer time, bandwidth, calendar period flat rate service, or any other mutually satisfactory billing arrangement.

All consumer and commercial applications of the invention require cellular web devices and prepaid anonymous accounts (one time or via prepaid cards to “fill-up the bank”) or by credit card or direct billing for each device ESN by agreed unit of measure.

### DETAILED DESCRIPTION

The described apparatus, method and article generally pertains to methods, business processes and apparatus for remote, real-time, data and/or image collection, wireless transmission and distribution for access and use by authorized Internet users worldwide. However, it will be appreciated by those skilled in the art, that this is illustrative of only a few of the applications of the invention, which has greater applicability and utility in many other applications where the use of real-time data and/or image collection, transmission and presentation is involved. Equivalent structures and functions embodying the invention could be configured for other such applications without diverting from the spirit and scope of the invention as described in this disclosure.

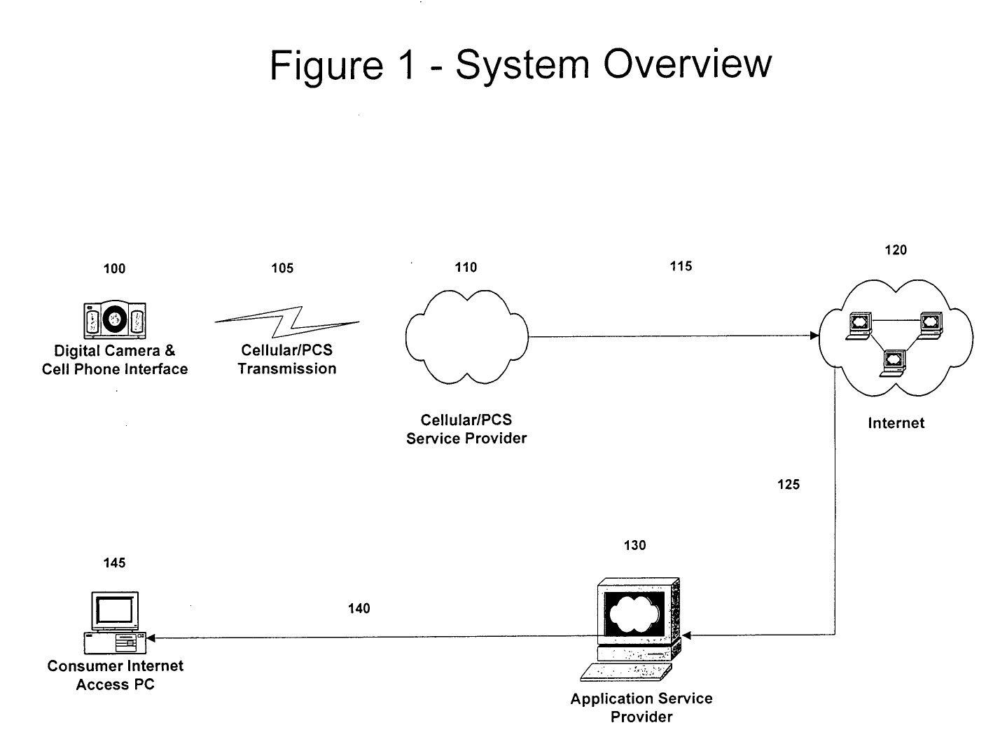

Referring to FIG. 1, a system overview is presented. While the invention is described in terms of a cellular web device, it could easily be a satellite interface web device.

Applications of the invention generally begin with a digital camera (disposable cellular or satellite interface web camera, “rechargeable” using prepaid photo cards, or standard digital camera with cellular web interface) or other data collection device with embedded cellular interface web communication device or interfaced cellular interface web device as shown at 100. A cellular or PCS (personal communications service) service provider 110 that accepts the data device “phone call” or cellular/PCS transmission 105 and recognizes it as a data call and then packages the packet data with the device electronic serial number (ESN), such as IP address or other suitable identifier, and forwards it to the appropriate application service provider 130. The “phone call” could be made to a specially designated number such as 611, 411 or 911 that are now accommodated on cellular phones. For example, the number 777 could be allocated as the “standard” data/image upload “phone number”. The routing from CSP 110 to an appropriate ASP 130 can be accomplished by a database lookup at the CSP 110 that correlates Device 100's ESN with ASP 130. Once the ASP 130 receives the data it then performs a database lookup with the data device 100 ESN as the key to determine what to do with the data. The data is then organized for subsequent access by authorized users 145 via the Internet 120. An ESN is assigned to the data originating device or data transmission interface device. This ESN is used to access the CSP system 110 and is used again by the ASP 130 to determine disposition of data and is used again finally by the end user 145 as a key element of the required access credentials.

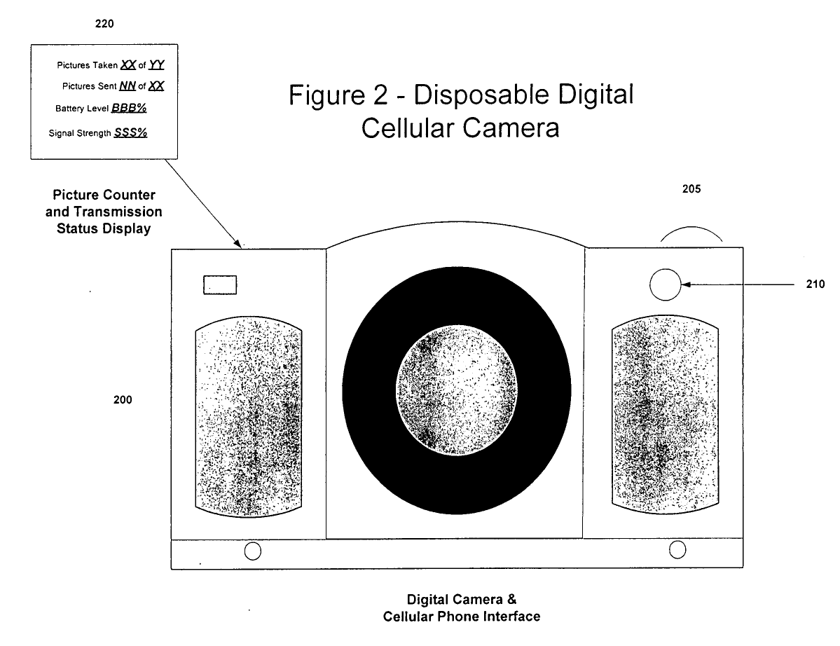

One business process application is the assignment of an initial password to a disposable cellular web camera 200, seen generally in FIG. 2, via a package insert. The package insert would be visible only after the package was opened and would be a removable card for future access of images taken with the camera 200. Additionally, for “rechargeable” cellular web cameras, the prepaid cards used to recharge the camera have similar codes that are used to authorize the transfer and access of additional images using the system. When the prepaid cards are purchased via cash, check or credit card in retail store locations or over the web, they are activated by going online to the appropriate ASP 130 website (URL is printed on the Prepaid Photo Card) and then linking the prepaid photo card key with a particular ESN. This in turn authorizes that particular ESN for an additional block of image transfers utilizing a particular CSP 110 which has already received compensation via the sale of the prepaid card.

With continued reference to FIG. 2, item 205 is the camera “shutter” button used to take pictures. Item 210 is a special emergency button that immediately sends the last image taken to 911 in addition to its normal route. This function can be used to signal emergency response authorities of any particular circumstance (crime, accident, fire, natural disaster) via a real-time digital photograph. Item 220 is one possible user interface implementation of the invention to provide camera 200 status information to the user such as cellular web camera signal strength, number of pictures taken and available, battery condition, and the like.

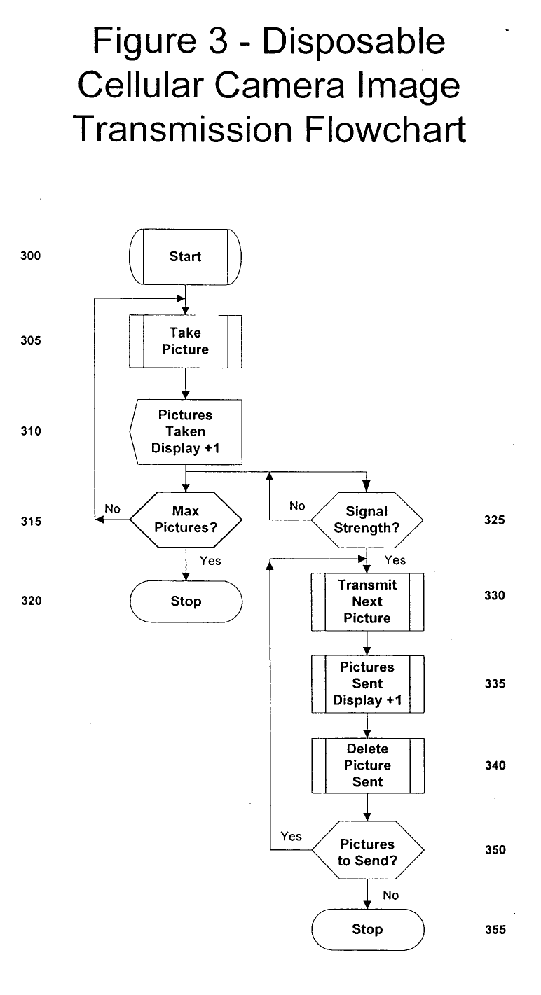

Applications follow data transmission logic similar to that of the cellular web camera shown in FIG. 3. Once images are captured via the camera 200 using the “shutter button” 205, the camera display 220 is updated to illustrate that one more image has been captured (picture taken) and the corresponding counters are incremented as shown in the flowchart 300 through 310. If the last picture available was taken, image 27 out of 27 as an example, for a device sold with a 27 image capacity, the camera, i.e., the image capturing portion of the device would then stop 320. Meanwhile, presuming adequate signal strength 325, the cellular web portion of the device would be transmitting captured images until they were all sent and received 330 though 355. Note that in step 340, this particular application of the invention deletes the photo from the device after successfully transmitting the image. This prevents undesired access of photos from discarded disposable cellular web camera devices 200.

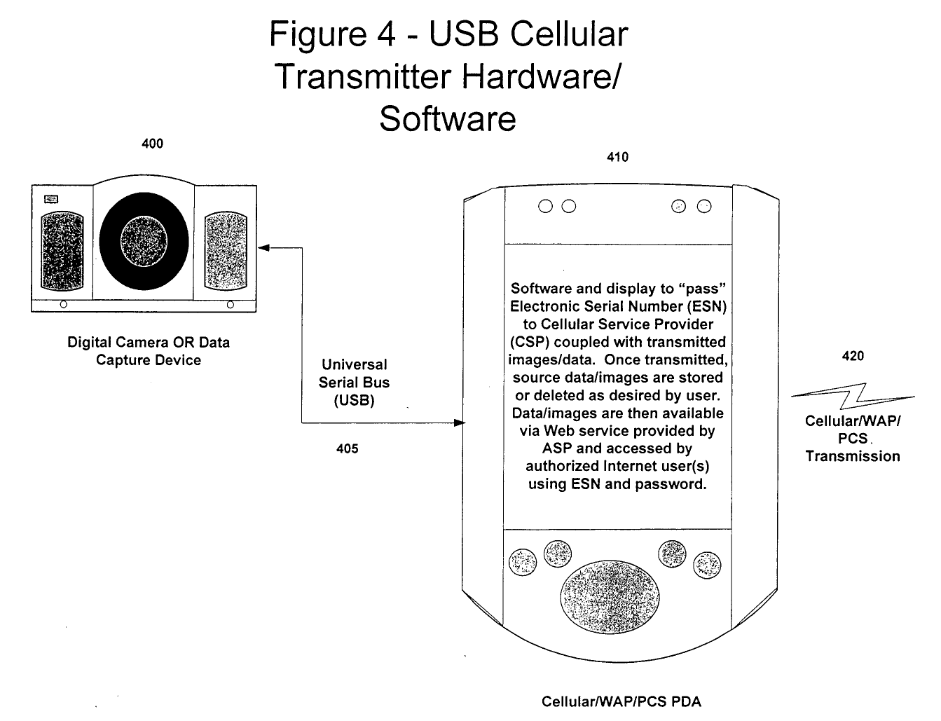

Additional invention utility is disclosed in FIG. 4. As seen generally in this figure, specialized software running on the PDA downloads the pictures or data (move or copy) from memory on the digital camera or data collection device and then transmits those pictures or data elements using the PDA's built in cellular connection via the CSP. More specifically, this diagram illustrates the use of existing image and data capture and storage devices 400 and how they may be used with cellular web access being provided by, in this example, a PDA with cellular access 410 running special Cellular Web Access software that “instructs” the CSP 110 what to do with the incoming “phone call” 420. The device shown in this example 400 could be any standard digital camera or other data collection and/or storage device with a standard interface such as a universal serial bus (USB) 405 used to connect it to the Cellular Web Access PDA 410. Many other applications of the invention could use specially designed and embedded cellular web access components such as the public safety, parcel delivery and public utility examples cited earlier in this invention disclosure. The invention would provide capability for completely unmanned operations such as video or photo capture for surveillance or reading gas meters real-time at desired frequency intervals that were never practical prior to this invention.

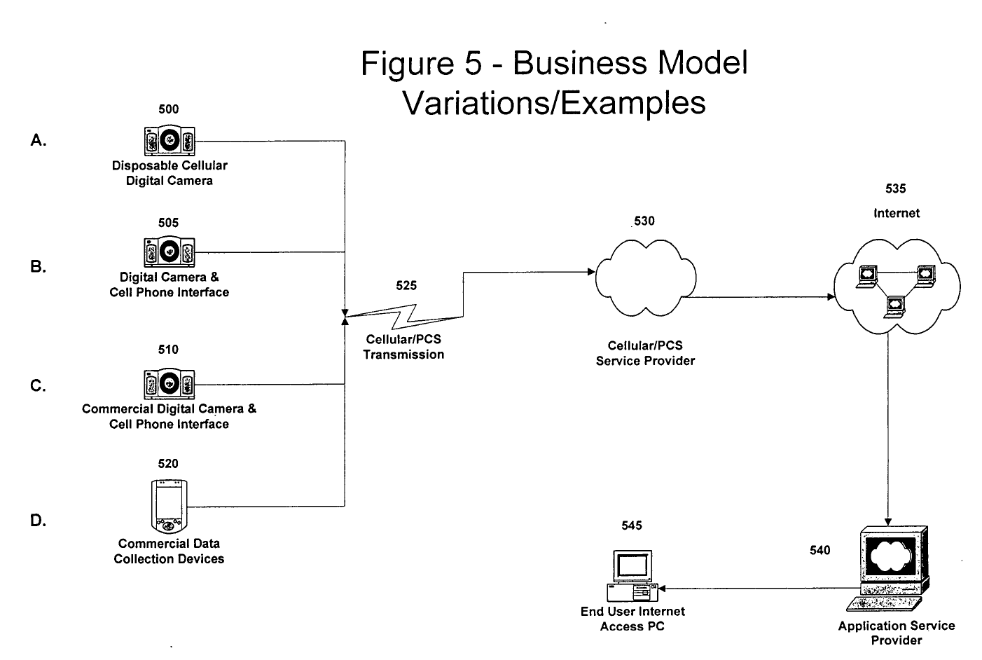

FIG. 5 illustrates several possible variations of the application of the invention. Example A shows the Disposable Cellular Web Camera where the end user is a buyer, or buyer authorized user, of the disposable camera who received the Internet/ASP access credentials. Example B illustrates a consumer with a generic digital camera and Cellular Web interface device that allows pictures to be accessed with ASP access credentials. Example C depicts a commercial user application, perhaps newspaper reporters or public safety officer cameras that trap real-time images of field operations. In this example, the ASP would have a custom interface that collects multiple Cellular Web interface device Electronic Serial Numbers (ESNs) and then displays or transfers the aggregated collections to the newspaper or police department dispatch centers. Example D depicts commercial applications of Cellular Web interface devices for data collection. Parcel delivery personnel using package scanners to provide timely package delivery status to clients could use this type of device to make the updates real-time. Utility readers could use this to eliminate needed trips back to the central office from the field for data downloading. Ultimately, this type of device could be embedded in the gas meter and preclude the need for meter readers altogether. Again, in this example, the data collected by multiple different devices would be aggregated for data transfer or display to the owner of their respective device ESN. More specifically, the branch denoted as A begins at 500. This branch is the disposable and/or rechargeable consumer cellular web camera application described earlier in this invention disclosure. Consumers of this embodiment of the invention enjoy complete anonymity. One business process disclosed herein is the revenue agreement between the device 500 manufacturers that receive the revenue from the sale of the product to the retail outlet or distributor and the CSP 530 that gets a predetermined block of revenue for each device 500 sold that compensates it for providing the transmission service and the ASP 540 that receives predetermined front-end revenue when the device 500 is sold for providing ultimate photo access via the web. In some applications of the invention, ASP 540 may derive tail-end revenue and ongoing monthly revenue as it relates to customization and additional functionality up-sells to consumers, end users 545. Other applications of the business processes of the invention describe large ISP (such as well known providers AOL, MSN, Earthlink) desire to participate in the marketing of devices such as 500 as a means of getting their respective ISP access CDs packaged with the device 500 in the pursuit of more ISP customers. This business process would include payment for cross promotion of the ISP services within the context of the device 500 sale that will ultimately require Internet access to use it.

Branch B of FIG. 5 starting with 505 shows the aforementioned application of the invention using standard interfaces such as USB to equip existing digital cameras and other data collection and storage devices for cellular web access. This branch is interesting as the business process used herein could be by prepaid billing as described earlier in the A branch, or could be via direct billing or by credit card as cellular phone services are at present for voice communication. Several examples of per unit billing mechanisms whether prepaid, direct billed or paid via credit card and tied to the CSP via the device ESN are possible. Billing information, account status, data access and all other needed end user interface is handled via the ASP 540 web site(s) in this example of the invention.

Branch C of FIG. 5 beginning with 510 illustrates possible commercial and government applications of the invention. While these applications could use disposable, rechargeable or existing devices with interfaces, the invention provides for aggregation and consolidation of multiple data streams from multiple devices each with a unique ESN into one data feed (parcel delivery example disclosed earlier) from the ASP 540 or web interface (public safety dispatch center example disclosed earlier) provided by the ASP 540. These applications of the invention provide for flexible and readily customizable solutions offered via the ASP 540. One business process application of the invention is the case of newspaper reporters all using unique devices with unique ESNs that are billed to the newspaper directly and the data is aggregated and displayed automatically on a central secure web site for interactive editorial staff to use as a palette of “late breaking” or real-time images to embed in their respective web offerings. In this model, the CSP 530 would have a direct per unit (minute of transmission time used, MB of data transferred or bandwidth used, or perhaps flat monthly per device fee up to a certain number of records) billing relationship with the newspaper. Additionally, the ASP 540 that is providing the interface, application, data storage, web access bandwidth, etc. would have a direct billing relationship with the newspaper as well on a predefined unit basis.

Branch D of FIG. 5 beginning with 520 shows essentially the same model as Branch C except that the data being collected could be very small fragments of information, not discrete files as is the case with photo transmission. Examples of these fragments, using the parcel delivery service example of the application of the invention, could include package scans that capture time, date, package ID, scan employee (if not automated), location and other pertinent information in a single record. The business process here utilizes billing schemes as described earlier in this invention disclosure with different units applied (records, bytes, transmissions, etc.) and would almost certainly create an XML or other agreed protocol data feed from the ASP 540 to the end user organization (parcel delivery firm in this example) 545.

The invention is directed to methods, apparatus and business processes for enabling real-time, globally accessible, cost effective, wireless image and/or data transmission and presentation for several example consumer and commercial applications. The invention has features that may be useful in other applications. Furthermore, while the foregoing description has been with reference to particular embodiments of the invention, it will be appreciated that these are only illustrative of the invention and that changes may be made to those embodiments without departing from the principles of the invention, the scope of which is defined by the spirit and scope of this overall description.

I claim:

1. The process of making images or other data from an image capturing device or other data capturing device or a combination thereof available to one or more authorized user, said capturing device having an electronically readable device serial number and cellular Internet communication capability, said capturing device (a) providing use information specifying said one or more authorized user of said images or other data, (b) capturing said images or other data, and (c) accessing the Internet with said cellular Internet communication capability for initiating the transmitting of said images or other data to a service provider associated with said device serial number, the process comprising:
said service provider associating said device serial number and said use information to provide said images or other data to said one or more authorized user.

2. The process of claim 1 wherein said capturing device deletes an image or other data responsive to its being transmitted using said capability.

3. The process of making images or other data from an image capturing device or other data capturing device or a combination thereof available to one or more authorized user, said capturing device having an electronically readable device serial number and cellular Internet communication capability, said capturing device (a) providing use information specifying said one or more authorized user of said images or other data, (b) capturing said images or other data and (c) accessing a cellular service provider (CSP) or a personal communications service provider (PCSP) with said cellular Internet communication capability for initiating the transmitting of said images or other data to a service provider associated with said device serial number, the process comprising:
said CSP or PCSP transmitting said prepared images or other data to an application service provider (ASP) associated with said device serial number to enable said ASP to associate said device serial number and said use information to provide to said set of authorized users said images or other data.

4. The process of claim 3 wherein said capturing device deletes an image or other data responsive to its being transmitted using said capability.

5. An image capturing device or other data capturing device, or combination thereof, having cellular Internet capability and an apparatus to delete a captured image or other data after it is transmitted using said capability.

6. An image capturing device or other data capturing device, or combination of the foregoing, having an electronically readable serial number and cellular Internet access capability connectable through a cellular Internet accessible PDA for initiating the transmission of said images or other data to one or more authorized user by an Internet service provider, said PDA running software providing instructions for operating on said images or other data during their transmission to said one or more authorized user.

7. The device of claim 6 wherein said instructions are provided by cellular Internet access or by satellite access.

8. The device of claim 7 wherein said device captures images or other data for parcel delivery applications, for public safety applications, for public utility applications, or a combination of any of the foregoing.

9. The device of claim 5 wherein said image or other data, or combination thereof, is captured without the use of a human at the site and time of said capture.

10. The device of claim 6 wherein said device is a disposable camera.

11. An image capturing device or other data capturing device, or combination of the foregoing, having an electronically readable serial number and cellular Internet access capability connectable through a cellular Internet accessible PDA for transmitting said images or other data to a CSP or a PCSP, said PDA running software providing said CSP or PCSP with instructions for operating on said images or other data.

12. The device of claim 11 wherein said instructions are provided to said CSP or PCSP over cellular Internet access or by satellite access.

13. The device of claim 11 wherein said device captures images or other data for parcel delivery applications, for public safety applications, for public utility applications, or a combination of the foregoing.

14. The device of claim 12 wherein said image or other data, or combination there, is captured without the use of a human at the site and time of said capture.

15. A PDA having cellular Internet access capability for receiving images or other data from a device also having cellular Internet access capability, said images or other data having been captured by said device, said PDA using its cellular Internet access capability for transmitting said images or other data over the Internet for delivery to one or more authorized user, said PDA running software providing instructions for operating on said images or other data during such delivery.

16. The PDA of claim 15 wherein said images or other data relate to parcel delivery applications, to public safety applications, to public utility applications, or to a combination of the foregoing.

17. The PDA of claim 16 wherein said image or other data, or combination thereof, is captured without the use of a human at the site and time of said capture.

18. A PDA having cellular Internet access capability for receiving images or other data from a device also having cellular Internet access capability, said images or other data having been captured by said device, said PDA using its cellular Internet access capability for transmitting said images or other data to a CSP or a PCSP, said PDA running software providing said CSP or PCSP with instructions for operating on said images or other data.

19. The PDA of claim 18 wherein said instructions are provided to said CSP or PCSP over cellular Internet access or by satellite access.

20. The PDA of claim 19 wherein said images or other data relate to parcel delivery applications, to public safety applications, to public utility applications, or to a combination of the foregoing.

21. The PDA of claim 20 wherein said image or other data, or combination thereof, is captured without the use of a human at the site and time of said capture.

22. The PDA of claim 18 wherein said device is a disposable camera.

23. A business process comprising:
a manufacturer of an image capturing device or other data capturing device, or combination thereof,
said device having an electronically readable device serial number and cellular Internet communication capability for accessing the Internet to initiate delivery of said images or other data by a service provider to an authorized user,
entering into a business arrangement providing for said service provider receiving a predetermined amount of revenue for each said device sold as at least partial compensation for providing said images or other data to said authorized user.

24. The process of claim 23, said business arrangement further providing that said service provider will receive tail-end revenues, ongoing revenues, or a combination thereof, for customized or additional functionality sold to authorized users or other users by or for said service provider.

25. A business process comprising:
a manufacturer of an image capturing device or other data capturing device, or combination thereof,
said device having an electronically readable device serial number and cellular Internet communication capability for accessing with said capability a CSP or PCSP for delivery of said images or other data to one or more authorized user,
entering into a business arrangement providing for said CSP or PCSP receiving a predetermined amount of revenue for each said device sold as at least partial compensation for providing said images or other data to an ASP.

26. The business process of claim 25 further including also providing for said ASP receiving a predetermined amount of revenue as at least partial consideration for providing said images or other data to said one or more authorized user.

27. The process of claim 25, said business arrangement further providing that said ASP will receive tail-end revenues, ongoing revenues, or a combination thereof, for customized or additional functionality sold to authorized users or other users by or for said ASP.

28. A billing arrangement process for a business accepting images or other data from a device having an electronically readable device serial number and cellular Internet communication capability for accessing the Internet with said capability to initiate delivery of said images or other data to an authorized user by a service provider, said business arrangement comprising:
the manufacturer or seller of said device agreeing that said service provider will provide billing services to the user of said device by prepaid, direct or credit card billing.

29. The billing arrangement of claim 28 further including billing information, account status, data access or a combination of the foregoing being displayed at a website authorized for use by the user of said device.

30. A billing arrangement process for a business accepting images or other data from a device having an electronically readable device serial number and cellular Internet communication capability for accessing with said capability a CSP or PCSP for delivery of said images or other data to an authorized user by an ASP, said business arrangement comprising:
the manufacturer or seller of said device agreeing with said CSP or PCSP that an ASP will provide billing services to the user of said device by prepaid, direct or credit card billing.

31. The billing arrangement process of claim 30 further including billing information, account status, data access or a combination of the foregoing being displayed at a website authorized for use by the user of said device.

32. The process of aggregating into one information feed multiple data streams of images or data, or a combination thereof, received via cellular Internet transmission from a plurality of devices each having an electronically readable device serial number and cellular Internet communication capability for initiating delivery of said images or other data to a service provider,
said one information feed being displayed for at least authorized user by said service provider.

33. The process of a CSP or PCSP aggregating into one information feed multiple data streams of images or data, or a combination thereof received via cellular Internet transmission from a plurality of devices each having an electronically readable device serial number and cellular Internet communication capability for initiating delivery of said images or other data to an ASP,
said one information feed being displayed for an authorized user by said ASP.

34. The process of an ASP aggregating into one information feed multiple data streams of images or data, or a combination thereof received via cellular Internet transmission from a plurality of devices each having an electronically readable device serial number and cellular Internet communication capability for initiating delivery of said images or other data to an ASP,
said one information feed being displayed for one or more authorized user by said ASP.

35. The process of claim 1 wherein said images or other data are displayed in a parcel delivery application wherein parcel delivery persons capture parcel delivery images or other data by said devices for display for one or more authorized user, a newspaper reporter application in which reporters use said devices for capturing images or other data and writing news stories for interactive use by an editorial staff, or public safety applications in which public safety officers use said devices to capture images or other data for display for public safety situations, or meter reading applications in which meter readers use said devices for capturing images or data for displaying meter readings.

36. The process of claim 35 wherein said ASP bills the organization whose employees use said devices, said billing being on a per unit of time used basis, a per amount of data transferred basis, a per bandwidth used basis, a flat monthly device fee basis, or a combination of the foregoing.

37. The process of aggregating into one information feed multiple data streams of fragmentary data received via cellular Internet transmission from a plurality of devices each having an electronically readable device serial number and cellular Internet communication capability for initiating delivery of said images or other data to a service provider,
said one information feed being displayed using an XML or other agreed protocol data feed for displaying said images or other data to one or more authorized user by said service provider.

38. The process of a CSP or PCSP aggregating into one information feed multiple data streams of fragmentary data received via cellular Internet transmission from a plurality of devices each having an electronically readable device serial number and cellular Internet communication capability for accessing with said capability a CSP or PCSP for delivery of said images or other data to an ASP,
said one information feed being displayed using an XML or other agreed protocol data feed for displaying said images or other data to an authorized user by said ASP.

39. The process of an ASP aggregating into one information feed multiple data streams of fragmentary data received via Internet transmission from a plurality of devices each having an electronically readable device serial number and cellular Internet communication capability for accessing with said capability a CSP or PCSP for delivery of said images or other data to an ASP,
said one information feed being displayed using an XML or other agreed protocol data feed for displaying said images or other data to one or more authorized user by said ASP.

40. The process of making images or other data from an image capturing device or other data capturing device, or a combination thereof available to one or more authorized user, said capturing device capturing said images or other data, said capturing device having an electronically readable device serial number and cellular Internet communication capability, the process using use information specifying one or more authorized user of said images or other data, said process comprising:
accepting accessing from said capturing device via said cellular Internet capability and recognizing it as a call communicating said images or other data to be provided to a set of authorized users, preparing said images or other data for transmission to said set of authorized users, said process including using said device serial number for preparing said images or other data for transmission; and
transmitting said prepared images or other data to a service provider associated with said device serial number for enabling said service provider to associate said device serial number and said use information to provide to said set of authorized users said images or other data.

41. The process of claim 40 wherein said capturing device deletes an image responsive to its communication over the Internet.

42. The process of making images or other data from an image capturing device or other data capturing device, or a combination thereof available to one or more authorized user, said capturing device having an electronically readable device serial number and cellular Internet communication capability, the process using use information specifying said one or more authorized users of said images or other data, said process comprising:
an ASP receiving from a CSP or a PCSP said images or other data that are provided to said CSP or PCSP as a call from said capturing device using said capability, said ASP associating said serial number and said use information to provide said images or other data to said one or more authorized user.

43. The process of claim 42 wherein said capturing device deletes an image or other data responsive to its being provided to said CSP or PCSP.

44. The process of making images or other data from an image capturing device or other data capturing device, or a combination thereof available to one or more authorized user, said capturing device capturing said images or other data, said capturing device having an electronically readable device serial number and cellular Internet communication capability, the process using use information specifying one or more authorized user of said images or other data, said process comprising:
a CSP or a PCSP (a) accepting accessing from said capturing device and recognizing it as a call communicating said images or other data to be provided to said one or more authorized user and (b) preparing said images or other data for transmission to said one or more authorized user, said process including using said device serial number for preparing said images or data for transmission; and
said CSP or said PCSP transmitting said prepared images or other data to an ASP associated with said device serial number for enabling said ASP to associate said device serial number and said use information to provide to said one or more authorized user said images or other data.

45. The process of claim 44 wherein said capturing device deletes an image responsive to its communication to said CSP or PCSP.
